(19) United States
(12) Patent Application Publication
(10) Pub. No.: US 2013/0081301 A1
(43) Pub. Date: Apr. 4, 2013

(54) Stiction-free drying of high aspect ratio devices

(71) Applicants: Roman Gouk, San Jose, CA (US); Steven Verhaverbeke, San Francisco, CA (US); Han-Wen Chen, San Mateo, CA (US)

(72) Inventors: Roman Gouk, San Jose, CA (US); Steven Verhaverbeke, San Francisco, CA (US); Han-Wen Chen, San Mateo, CA (US)

(73) Assignee: Applied Materials, Inc.

(21) Appl. No.: 13/200,789

(22) Filed: Sep. 30, 2011

(51) Int. Cl. F26B 3/00; F26B 21/14

(52) U.S. Cl. 34/443; 34/523

(57) ABSTRACT

A method of removing a water-comprising rinse/cleaning material from the surface of a device which includes high aspect ratio features (an aspect ratio of 5 or greater) where sidewalls of the feature are separated by 50 nm or less without causing stiction between the feature sidewall surfaces. The method relies on the use of a low surface tension drying liquid which also exhibits a high evaporation rate. The method also relies on a technique by which the drying liquid is applied. Increasing the evaporation rate of the drying liquid and application of the drying liquid in the form of a vapor helps to eliminate stiction.

### TECHNOLOGY FIELD

The present application is related to a method which reduces feature sidewall collapse during wet cleaning after an etching process during semiconductor microelectronics device fabrication or during MEMS fabrication.

### DESCRIPTION OF THE BACKGROUND

This section describes background subject matter related to the disclosed embodiments of the present invention. There is no intention, either express or implied, that the background art discussed in this section legally constitutes prior art.

Feature sidewall collapse during fabrication of high aspect ratio semiconductor device structures is a particular problem when spacings between feature dimensions are below 50 nm and the feature includes sidewalls with an aspect ratio greater than about 5. This problem is frequently observed with respect to electronic memory storage devices, such as NAND flash memory devices, for example, where line structures collapse during wet cleaning and drying of the etched line structures.

Line collapse during fabrication of semiconductor device structures such as memory devices, for example, frequently occurs during post-etch wet cleaning and drying of floating gates or lever arms. The line collapse is attributed to stiction in the high aspect ratio features. The liquid surface tension created and the molecular attraction effects between sidewalls of floating lines or lever arms in close proximity is readily apparent. In one particularly important application, semiconductor memory devices have floating gates in a gate stack, where the STI ½ pitch (spacings between floating gate lines) are below about 50 nm, and the line structures have an aspect ratio which is greater than about 5. Stiction of the line feature surfaces frequently occurs during post etch wet cleaning and drying.

The stiction problem is becoming more important as device sizes shrink. For example, with respect to semiconductor memory products, in 1995, the MPU/ASIC Metal 1 spacing between lines in a gate structure (STI ½ pitch) was about 650 nm. By 2010, the STI ½ pitch was about 45 nm. By 2020, the expected STI ½ pitch is about 12 nm. In 1995, the DRAM ½ pitch (contacted) was about 350 nm. By 2010, the same DRAM ½ pitch was about 41 nm. By 2020, the expected DRAM ½ pitch is about 13 nm. In 1995, the Flash Poly ½ pitch (un-contacted) was about 350 nm. By 2010, the same Flash Poly ½ pitch was about 30 nm. By 2020, the expected Flash Poly ½ pitch is about 9.3 nm. As these feature sizes have been decreasing, the problem of stiction between the surface of feature side walls has been becoming progressively worse.

FIG. 1 shows a schematic drawing of a floating gate NAND STI structure 100, with the spacing 102 between floating gate lines 104. FIG. 2 shows a photomicrograph 200 of severe collapse 202 of STI lines 204 in a gate structure 206 after fabrication, where the spacing 208 between lines 204 is 26 nm. High aspect ratio features (having aspect ratios above about 12) in floating gate devices dominate the flash memory market, and the line stiction/collapse which occurs during cleaning and drying of post-etch gate structures needs to be addressed.

FIG. 3 shows a schematic diagram of a pattern collapse 302, with the variables which affect feature sidewall 304 collapse illustrated in equation 303. Equation 303 enables the calculation of a deformation distance (δ) 306 in nm, which is related to stiction. FIG. 4 shows a graph 402 of the calculated deformation distance (δ) 404 in nm as a function of the half pitch (line spacing) 408 in nm, and the aspect ratio 406. The aspect ratio 406 is dependent on the height of a line 308, (shown as H in FIG. 3) and the spacing between lines 310, 9shown as d in FIG. 3). In FIG. 4, the deformation distance δ during the post-etch cleaning and drying process in which stiction occurs, is illustrated for solvents which have been generally used in the art in cleaning and drying processes in the past: a) water; b) isopropyl alcohol; c) ethanol; and d) ethoxy-nonafluorobutane. As is apparent from FIG. 4, at an aspect ratio as low as 5, when the spacing between the gate lines is less than about 50 nm, the deformation distance in nm is such that stiction is highly likely to occur for all of the cleaning and drying agents illustrated. Ethoxy-nonafluorobutane looks the best (with a deformation distance of about 30 nm, when the half pitch spacing is about 20 nm); but even in this best case, there is likely to be contact between lines which may lead to collapse of the lines at periodic points.

A survey of the known art related to cleaning processes used in the semiconductor and MEMS industries indicates that others have observed similar problems with respect to fabrication of device structures. One typical example is provided in U.S. Pat. No. 5,722,902 to Reed et al., issued Jun. 30, 1998, which relates to a method of preventing adhesion of micromechanical structures. A method is provided for inhibiting stiction of suspended Microstructures during post-release-etch rinsing and drying. The microstructures are shaped to include additional convex corners at regions of the released portion of the microstructure that can undergo substantial displacement toward the substrate. Methods for inhibiting stiction are also provided wherein high-temperature rinse liquid is used and wherein a high temperature anneal follows a rinsing step. (Abstract)

Other examples of attempts to avoid stiction problems are described in U.S. Pat. No. 6,669,785 to De Young et al., issued Dec. 30, 2003, which describes a method of cleaning a microelectronic substrate using a cleaning fluid comprising an adduct of hydrogen fluoride with a Lewis base in a carbon dioxide solvent. U.S. Pat. No. 7,517,809 to Korzenski et al, issued Apr. 14, 2009, describes a method and composition for removing silicon-containing sacrificial layers from Micro Electro Mechanical Systems (MEMS) and other semiconductor substrates having such sacrificial layers. The etching compositions include a supercritical fluid (SCF), an etchant species, a co-solvent, and optionally a surfactant. The resultant etched substrates are said to experience lower incidents of stiction relative to substrates etched using conventional wet etching techniques.

U.S. Pat. No. 7,892,937 to Rana et al., issued Feb. 22, 2011 relates to method of forming capacitors. Storage nodes are formed within a material. The storage nodes have sidewalls along the material. Some of the material is removed to expose portions of the sidewalls. The exposed portions of the sidewalls are coated with a substance that is not wetted by water. Additional material is removed to expose uncoated regions of the sidewalls. The substance is removed and then capacitor dielectric material is formed along the sidewalls of the storage nodes. Capacitor electrode material is then formed over the capacitor dielectric material. Some embodiments include methods of utilizing a silicon dioxide-containing masking structure in which the silicon dioxide of the masking structure is coated with a substance that is not wetted by water. (Abstract) Some embodiments include methods in which surfaces are protected with hydrophobic and/or non-wetting material to alleviate, and possibly prevent stiction between adjacent surfaces during subsequent etching, rinsing and/or drying processes. (Col. 3, lines 21-25).

A review of various attempts to avoid stiction during post-etch wet cleaning shows that complicated procedures and specialty materials which are costly have been used to try to reduce or avoid stiction between closely spaced features where capillaries may form and features may be drawn together to cause structure collapse. There remains a need for a simple procedure for post-etch wet cleaning which does not require the use of cleaning materials which are difficult to handle and to recycle.

### SUMMARY

We have developed a method of removing a water-comprising rinse material from the surface of a device which includes high aspect ratio features (an aspect ratio of 5 or greater) which are separated by 50 nm or less without causing stiction between feature surfaces. The method is particularly helpful during fabrication of electronic memory storage devices, such as NAND flash memory devices, for example and not by way of limitation. The method relies on the use of a drying liquid which not only exhibits a low surface tension, but also exhibits a high evaporation rate. The method also relies on a technique by which the drying liquid is applied. We have discovered that increasing the evaporation rate of the drying liquid which is used in combination with particular techniques for application of the drying liquid can help to eliminate stiction, so that advanced NAND flash memory devices, and other semiconductor devices with high aspect ratio lines are manufacturable with higher yields. Application of the drying liquid in the form of a vapor is particularly helpful.

A substrate containing devices is first rinsed with deionized water, so that the devices are uniformly wet, with the deionized water being present in spaces between feature surfaces. For example, the spaces between feature lines which make up floating gates of a NAND STI structures are full of water (which supports the lines and maintains a spacing between the lines). Subsequently, the wet surface of the device is exposed to vapor of a drying liquid (or a mixture of liquids) where the liquid is very highly miscible with water (80% miscibility minimum); where the liquid has a very high evaporation rate (at least 4 relative to butyl acetate at 1); and where the drying liquid tends not to react with the surface of the substrate which is exposed between the lines. The purpose of the treatment with the drying liquid vapor is to remove the water, and to create a surface coating of the drying liquid on the exterior surfaces of the lines, and between the lines to support the lines. The drying liquid coating is then removed very rapidly, in a manner such that stiction does not occur between adjacent feature sidewall surfaces (line sidewall surfaces, for example). It appears that, due to the very rapid removal of the drying liquid coating, the sidewalls of the feature do not contact each other for a time sufficient to create the stiction, i.e. the sidewalls do not slowly collapse, making contact for a time period which results in stiction. Orientation of the substrate on which the devices are present, a wafer substrate for example, is typically adjusted to help facilitate the water removal from the feature sidewall surfaces and to help facilitate removal of the drying liquid in a manner which reduces the possibility of stiction-causing contact of the sidewall surfaces. In one helpful embodiment, the surface of the wafer which comprises the device structures is placed so that it is suspended above the source of the vapor. In one helpful embodiment the surface comprising the device structures is placed perpendicular to the direction of drying liquid vapor flow. This permits the liquid vapor to rise to gently contact the device structures and permits condensed liquid vapor containing water to fall away, due to gravity, from the devices without pushing the sidewalls of the structures together.

While preference is given to a drying liquid which is 100% miscible with water, it is possible to use a drying liquid which is at least 80% miscible with water. The evaporation rate of the drying liquid, or liquid with additive, or combination of liquids should be about 4.0 or greater, where the reference is butyl acetate, which has been assigned an evaporation rate value of 1.0. Further, reactivity of the drying liquid, or combination of drying liquids, or drying liquid with an additive, which is contacted with exposed feature walls, must be such that the performance of the substrate is not affected by the contact with the drying liquid.

When the substrate surface is a low-k dielectric, for example, the resistivity of the low-k dielectric should not increase by more than about 3% due to the surface cleaning, and in general such an increase should be 1% or less due to contact with the drying liquid.

In one embodiment of the invention, the device is a NAND flash memory device which includes floating gates in a gate stack where the STI ½ pitch dimensions are 50 nm down to about 10 nm, and where the aspect ratio of the line structures in the floating gate stack ranges from about 5 up to about 20. A particularly advantageous drying liquid (drying agent) is a simple compound. We have discovered that acetone [(CH₃)₂CO], which is 100% water miscible and which can be recovered from the water and recycled, if desired (using distillation processes, for example) works particularly well. The drying liquid/agent is heated to or near its boiling point (56° C. for acetone at atmospheric pressure) to create a vapor which can move and flow over the surface of the devices (which are typically present on a silicon wafer substrate, for example, but may be present on other substrates as well). After a wafer surface containing the devices is DI water rinsed, the wet surface of the wafer is exposed to the acetone vapor such that acetone is condensed on the wafer surface. During application of the acetone vapor to the wafer surface, it is helpful to have the wafer surface oriented horizontally, facing the ground, with the source of the drying liquid vapor being such that the vapor rises upward to contact the wafer surface (vapor flow direction is perpendicular to the surface which is to be dried). When the tops of the features extending downward towards the ground, the benefit of gravity flow assists the condensed liquid/water solution separation from the wafer surface, as it drips off the substrate surface while fresh drying liquid vapor is condensing upon the wafer surface. This action has a washing effect.

In an alternative, the wafer surface may be moved in a manner which causes the condensed drying liquid/agent combined with deionized water to gradually leave the surface of the wafer. It is important that the space between the feature sidewalls be filled with condensed drying liquid/deionized water until the water has been removed and only condensed drying liquid is present on the wafer surface. For example, a wafer may be tilted or carefully, gently rotated to permit the acetone condensate to displace water. When all of the water is displaced, the wafer surface may be left facing ground or placed in a horizontal position to produce a more uniform acetone condensate coating on the feature surfaces. The source of the acetone vapor is then removed and the acetone condensate present on the wafer is surface rapidly evaporated. A typical time period required to displace water on the surface of a wafer with a drying liquid ranges from about 30 seconds to about 60 seconds. A typical time period required to evaporate the drying liquid ranges from less than one second to about three seconds. It is possible to leave the drying liquid present on the surface of the wafer containing the devices for any convenient period of time which does not harm the semiconductor devices. However, when evaporation of the drying liquid is initiated, the drying liquid needs to be removed as rapidly as possible, to avoid contact of wetted feature sidewalls for an extended period of time, which can lead to stiction. The wafer may be heated using a technology such as microwave to help reduce the time period required to obtain evaporation of the drying liquid.

### BRIEF DESCRIPTION OF THE DRAWINGS

FIG. 1 shows a schematic drawing of a NAND STI memory floating control gate structure (a word line structure).

FIG. 2 shows a photomicrograph of collapsed STI lines in a gate structure after a wet clean and dry, of the kind previously known in the art, where the spacing between lines is 26 nm and the aspect ratio of the lines is 12.

FIG. 3 shows a schematic diagram of the collapsing together of two lines, with the variables illustrated, including a calculated deformation distance δ, which is related to the surface tension γ of a cleaning solution present between the lines 304 of a floating gate feature 302.

FIG. 4 shows a graph which illustrates the calculated deformation distance δ of HAR (High Aspect Ratio) trench patterns as a function of half pitch (spacing between lines) of a floating gate feature of the kind shown in FIG. 3.

FIG. 5A shows a photomicrograph of a starting reference structure of NAND STI lines which was used to do preliminary wet-rinse and dry experimentation.

FIG. 5B shows a comparative sample embodiment produced using the starting structure shown in FIG. 5A, where the starting structure was subsequently exposed to a sprayed-on DI water rinse, followed by an IPA vapor dry at 83° C. The vapor dry was conducted using the technique shown in FIG. 10B, but without rotation of the starting structure substrate.

FIG. 5C shows a comparative sample embodiment produced using the starting structure shown in FIG. 5A, where the starting structure was exposed to a sprayed-on DI water rinse, followed by an ethyl acetate vapor dry at 77° C. The vapor dry was conducted using the technique shown in FIG. 10B, but without rotation of the starting structure substrate.

FIG. 5D shows a sample embodiment produced using the starting structure shown in FIG. 5A, where the starting structure was exposed to a sprayed-on DI water rinse, followed by an acetone vapor dry at 56° C. The vapor dry was conducted using the technique shown in FIG. 10B, but without rotation of the starting structure substrate.

FIG. 6A shows a comparative photomicrograph of collapsed lines of a floating gate NAND STI structure where the collapse of the lines is due to severe stiction which occurred during a rinse clean and drying process. The aspect ratio of the lines was 12 and the spacing between the lines was 13 nm.

FIG. 6B is a schematic drawing representing a spin rinse/dryer in which a sprayed-on water cleaning rinse was applied, followed by a spin dry to remove residual water. For comparative purposes, the vapor dry of the specimen shown in FIG. 6A was conducted using the apparatus shown in FIG. 6B.

FIG. 7A shows a comparative photomicrograph of a NAND STI structure where a portion of the lines has collapsed due to stiction which occurred during a DI wet rinse, where an IPA vapor dry was used to remove the residual water. The aspect ratio of the lines was 12 and the spacing between the lines was 13 nm.

FIG. 7B is a schematic representing an isopropyl alcohol dryer of the kind used for drying the DI water off the surface of the NAND STI structure shown in FIG. 7A.

FIG. 8A shows a representative drawing 800 of a film stack after etching and prior to wet clean and drying. The drawing is not to scale. The width 812 of the trench at the base of the NAND STI trenches is about 13 nm, and the aspect ratio (height of the trench walls relative to the width 812 at the base of the trench) is about 12. The base 802 of the substrate is silicon. A tunnel silicon oxide layer 804 overlying the substrate is about 7 nm thick. A polysilicon layer 805 about 95 nm thick overlies the tunnel oxide layer 804. A silicon nitride etch stop layer 806 about 30 nm thick overlies the polysilicon layer 805. The remaining hard masking layer 808 is about 90 nm thick. This was the basic structure of the specimens used during development of the present method of removing cleaning liquids from semiconductor device features.

FIG. 8B shows a photomicrograph top view 820 of a floating gate NAND STI structure after use of a drying process embodiment of the present invention, where there has been no stiction during the rinse/dry cleaning process. The cleaned lines have maintained their dimensional stability during the cleaning process. The aspect ratio of the lines was 12 and the spacing between the lines was 13 nm.

FIG. 8C shows a photomicrograph edge view 830 of a floating gate NAND STI structure after etch and prior to cleaning, where the spacing 832 between lines 834 (half pitch) is 26 nm and the stack height is about 350 nm.

FIG. 9A shows a photomicrograph edge view 900, and a top surface view 910 of an NAND STI structure having a 26 nm spacing between trenches and an aspect ratio of 12. The photomicrograph was taken subsequent to etching of the trenches and prior to any cleaning or drying.

FIG. 9B shows a photomicrograph edge view 920 and top surface view 930 of the NAND STI structure illustrated in FIG. 9A, where the photomicrograph was taken subsequent to a DI water rinse and an acetone vapor dry in accordance with an embodiment of the present invention.

FIG. 9C shows a photomicrograph edge view 940 and top surface view 950 of the NAND STI structure illustrated in FIG. 9A, but where an additional HF clean of the structure was carried out prior to the DI water rinse and acetone vapor dry in accordance with an embodiment of the present invention.

FIG. 10A is a schematic drawing showing one drying technique which may be used to remove residual DI rinse water from a semiconductor wafer device surface 1010 on which devices are present, for example. It is also possible to have the semiconductor wafer 1008 suspended vertically above the rising drying liquid vapors 1014. By using a restricting vapor exit (not shown) from the processing chamber 1006, it is possible to keep both the back side 1009 of the wafer and the wafer device surface 1010 completely contacted by vapor during a drying process 1014, which provides improved uniformity during drying of the wafer surface 1010.

FIG. 10B is a schematic drawing showing a drying technique which was determined to work particularly well, where the semiconductor wafer device surface 1010 faced horizontal to ground, with drying liquid vapors 1014 rising upward toward the wafer device surface 110. The wafer may be directly rotated 1018 to assist in the cleaning action and to direct used, condensed vapor 1012 toward a collection channel 1016 for processing to remove surface residue (not illustrated) cleaned off the wafer 1008 during the drying process.

FIG. 10C is a schematic drawing showing an alternative method of uniformly evaporating the drying fluid from the wafer device surface 1010, where the wafer device surface is facing away from ground. In addition, FIG. 10C shows an embodiment of the invention where a source of drying liquid vapor may be applied to both the device-comprising surface and the backside of a semiconductor substrate simultaneously.

### DETAILED DESCRIPTION OF EXEMPLARY EMBODIMENTS

As a preface to the detailed description, it should be noted that, as used in this specification and the appended claims, the singular forms “a”, “an”, and “the” include plural referents, unless the context clearly dictates otherwise.

When the word “about” is used herein, this is intended to mean that the nominal value presented is precise within ±10%.

We have developed a method of removing a water-comprising rinse material from the surface of a device which includes high aspect ratio features which are separated by 50 nm or less without causing stiction between feature surfaces. The method is particularly helpful during fabrication of electronic memory storage devices, such as NAND flash memory devices, for example and not by way of limitation. The method relies on the use of a low surface tension drying liquid which also exhibits a high evaporation rate. We have discovered that by using a drying liquid having a particular surface tension combined with a particular evaporation rate, it is possible to eliminate stiction, so that advanced NAND flash memory devices, and other semiconductor devices with high aspect ratio lines are manufacturable with higher yields.

A substrate containing devices is first rinsed with deionized water, so that the devices are uniformly wet with the deionized water being present in spaces between feature surfaces. For example, the spaces between feature lines which make up floating gates are full of water (which supports the lines and maintains a spacing between the lines). Subsequently, the wet surface of the device is exposed to vapor of a solvent (or a mixture of solvents) which is very highly miscible with water, which has a high evaporation rate, and which tends not to react with the surface of the substrate which is exposed between the lines. The purpose of the treatment with the solvent vapor is to remove the water, and to create a surface coating of the solvent on the exterior surfaces of the lines, and between the lines to support the lines. The solvent coating is then removed very rapidly, in a manner such that stiction does not occur between adjacent feature sidewall surfaces, line sidewall surfaces, for example. By way of possible explanation, it appears that, due to the very rapid removal of the solvent coating, the sidewalls of the feature do not contact each other for a time sufficient to create the stiction, i.e. the sidewalls do not slowly collapse, making contact for a time period which results in stiction. Orientation of the substrate on which the devices are present, a wafer substrate for example, may be adjusted to help facilitate the water removal from the feature sidewall surfaces and to help facilitate removal of the drying liquid in a manner which reduces the possibility of contact of the sidewall surfaces to facilitate stiction.

In particular, preference is given to a drying liquid which is 100% miscible with water. It is possible to use drying liquids which exhibit at least 80% miscibility with water in instances where such drying liquids provide especially helpful surface tension and evaporation rate characteristics. Preference is also given to a drying liquid having an evaporation rate of 4.0 or greater, with the reference being butyl acetate, which has been assigned an evaporation rate value of 1.0. Examples of drying liquids which are 100% water miscible and which have an evaporation rate of about 4.0 include acetone, by way of example and not by way of limitation. Examples of materials which are 100% water miscible, but which have an evaporation rate which is likely to somewhat lower than that of acetone, include 3-pentanone, 1-methoxy-2-propanol, and propylene glycol methyl ether, and isopropyl alcohol, by way of example and not by way of limitation. An example of materials have an evaporation rate which is expected to be about 4.0 or higher (based on vapor pressure), but which are not completely miscible are butanone, diethyl ether and hexane, by way of example and not by way of limitation. It is also possible to use mixtures of the drying liquids described above.

Further, reactivity of the drying liquid with substrate surfaces (adjacent feature exterior wall surfaces) contacted by the drying liquid must be such that the performance of the substrate is not affected by the contact with the drying liquid. In one embodiment, when the substrate surface is a low-k dielectric, for example, the resistivity of the low-k dielectric should not increase by more than about 3%, and typically should increase less than about 1%.

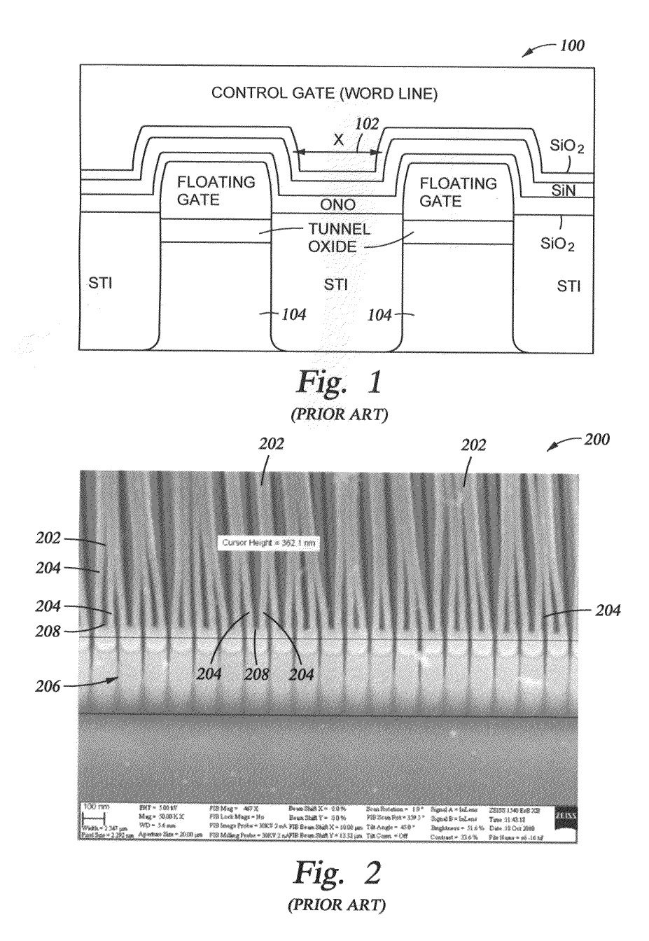

In one embodiment of the invention, the device is a NAND flash memory device which includes floating gates in a gate stack where the STI ½ pitch dimensions are 50 nm down to about 10 nm, and where the aspect ratio of the line structures in the floating gate stack ranges from about 12 up to about 20. An advantageous drying liquid (drying agent) is a simple compound, acetone [(CH₃)₂CO], which is 100% water miscible and which can be recovered from the water and recycled, if desired, using distillation processes, for example. The drying liquid/agent is heated to or near its boiling point (56° C. for acetone at atmospheric pressure) to create a vapor which can move and flow over the surface of the devices, which are typically (but not necessarily) present on a wafer substrate. A silicon substrate tends to be hydrophobic. However a silicon oxide surface of the kind present on the upper surface of a NAND flash memory device (as shown in FIG. 1) is hydrophilic. After a wafer containing the devices is DI water rinsed, water remains on the surface of the device. The water-wetted surface of the NAND flash memory device is then exposed to acetone vapor such that acetone is condensed on the surface of the NAND flash memory devices. During application of the acetone vapor to the wafer surface, it is helpful to have the wafer surface oriented so that the sidewalls of the high aspect ratio features extend downward, to obtain the benefit of gravity flow, so that condensed water/vapor mixture drips off the wafer surface while fresh drying liquid/agent vapor is condensing upon the wafer surface. This action has a washing effect, until the condensed drying liquid vapor completely coats the sidewalls of the features and typically fills the spaces between the sidewalls.

In an alternative, the wafer surface may be gently rotated while tilted, or otherwise moved in a manner which causes the condensed drying liquid/agent combined with deionized water to gradually leave the surface of the wafer. It is important that the space between the feature sidewalls be filled with sufficient condensed drying liquid to hold the sidewalls of the features apart in a manner which prevents stiction of the sidewalls. Deionized water/drying liquid solution is used to hold the space between feature sidewalls until the water has been removed and only condensed drying liquid is present on the wafer surface. A wafer is typically tilted or rotated to permit the acetone condensate to displace water and the solution of the materials to become increasingly concentrated in the amount of acetone present, by way of example. The acetone/water solution which is formed is permitted to flow off from the wafer surface while the surface is kept covered with acetone condensate. When all of the water is displaced, the drying liquid may be evaporated from the device surface of the wafer while the wafer device surface is facing ground or has been rotated to face away from ground, where a uniform drying liquid condensate coating is present on the feature surfaces, maintaining a spacing between the sidewalls of the features. The source of the drying liquid is then removed and the drying liquid present on the wafer surface is allowed to evaporate.

### Exemplary Embodiments

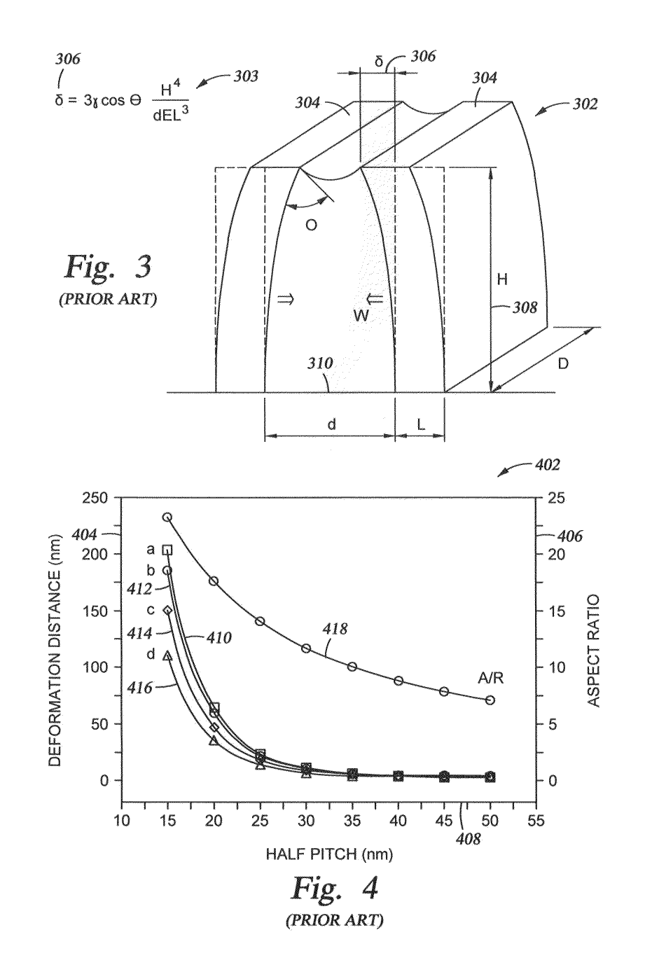

Comparative Example: FIG. 1 shows a schematic drawing 100 of a NAND STI memory floating control gate structure (feature) comprising word lines 104. The floating gate feature may collapse due to stiction during cleaning and drying of the post-etch patterned features when the spacing between lines 102 (X) is about 50 nm or less. FIG. 2 shows a photomicrograph 200 of collapsed 202 STI lines 204 in a floating gate structure 206 present in a memory structure of the kind shown in the schematic drawing 100. The collapse of lines 204 to produce the collapsed structure 202 occurred when a wet clean and dry were performed after etching of the floating gate features. In this particular instance, the spacing between lines was about 26 nm and the aspect ratio of the feature was about 12.

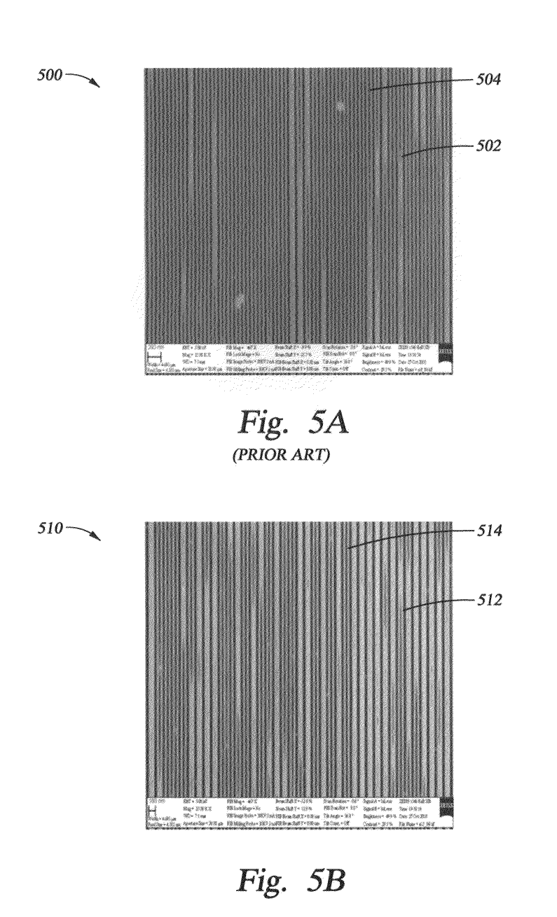

FIG. 3 shows a schematic diagram 302 of a published mechanism by which two lines 304 move toward collapse. Equation 303 permits calculation of a deformation distance δ 306. Surface tension is represented by γ, and E is young's modulus. The feature sidewalls 304, which have a width “L” and a height “H”. The length of the sidewalls is represented by “D”, and the distance between the interior surfaces of the sidewalls 304 is represented by “d”.

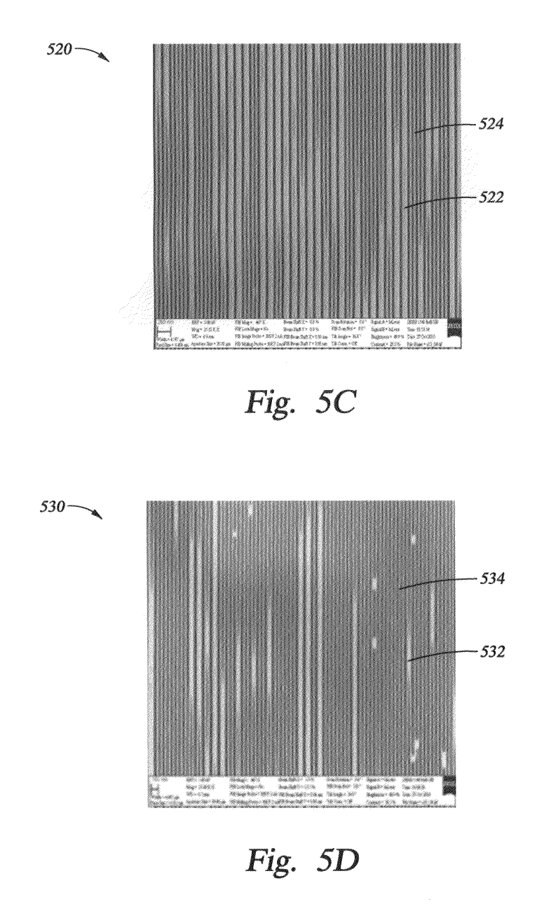

FIG. 4 shows a graph 402 which illustrates the calculated deformation distance δ 404 of a HAR trench pattern as a function of half pitch 408 for various drying liquids a, b, c, and d, and the aspect ratio 406 which is present at a given deformation distance δ 404 at a given half pitch 408. Curve a) represents water; curve b) represents isopropyl alcohol (IPA); curve c) represents ethanol; and, curve d) represents ethoxy-nonfluorobutane. FIGS. 3 and 4 are taken from a reference: G. H. Kim et al., “Effect of Drying Liquid on Stiction of High Aspect Ratio Structures”. UCPPS Proc. 2010. A combination of the information provided in FIGS. 3 and 4 indicates that despite the use of a low surface tension liquid for cleaning purposes, there may still be sufficient deformation of the sidewalls of the structure to collapse the structure.

We tested a limited number of drying liquids for comparative purposes. Comparative properties for these drying liquids are shown below in Table I.

TABLE 1

| | | | Surface | Surface | |
|---|---|---|---|---|---|
| | Boiling | Evaporation | Tension | Tension @ | Water |
| | Point | Rate | RT | Boiling | Miscible |
| Solvent | ° C. | (BuAc = 1) | (25° C.) | Point | (%) |
| Water | 100 | 0.3 | 72.8 | 58.8 | NA |
| IPA | 82.5 | 1.5 | 22 | 17 | 100 |
| Ethyl | 77 | 4.1 | 24 | 17 | 8 |
| Acetate | | | | | |
| Acetone | 56 | 6.6 | 23 | 18 | 100 |

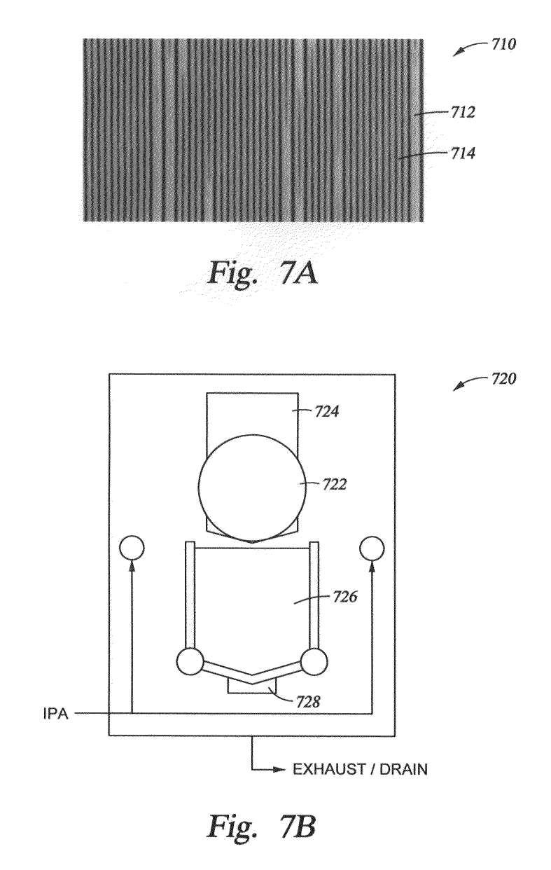

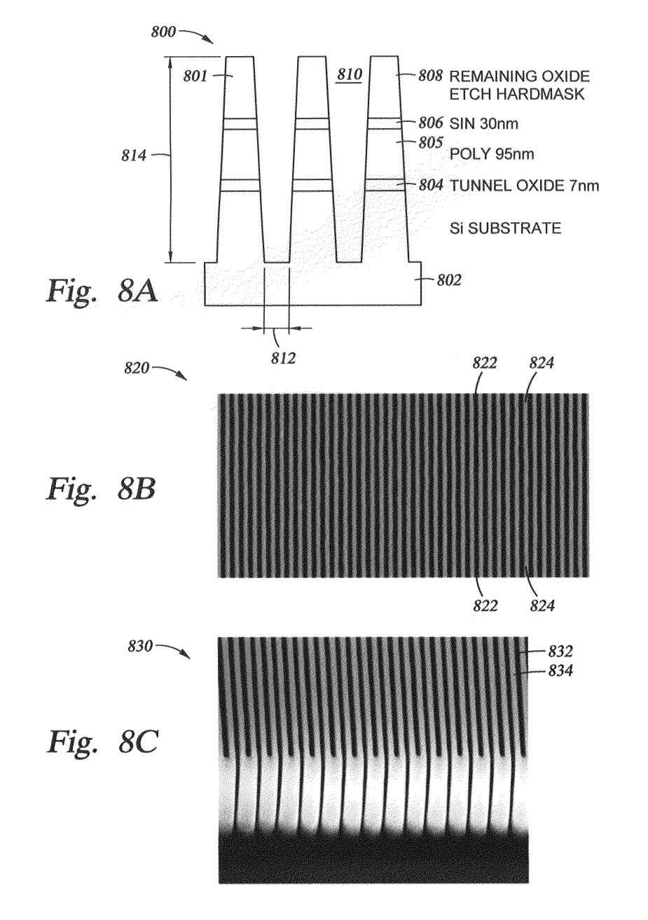

Conventional liquid drying methods have recently been based on the “Marangoni method” which is related to convection due to temperature and concentration gradients on a free surface. There are two typical manners in which the Marangoni method has been practiced during cleaning of a processed HAR NAND STI control gate with a floating control gate structure. In a first instance, a heated low tension cleaning liquid was applied using a horizontal spin tool of the kind illustrated in FIG. 6B, where the low surface tension cleaning liquid dries while the wafer is in a horizontal position. In a second instance, a wafer comprising the devices is placed vertically in a heated tank containing a low surface tension cleaning liquid, as illustrated in FIG. 7B. After a period of time, the wafer is pulled out and the low surface tension cleaning liquid is allowed to drip off until the wafer is dry. Both of these methods have caused non-uniform drying and typically causes stiction (of the kind illustrated in FIGS. 6A and 7A, respectively).

As discussed above, calculations based on equation 303 shown in FIG. 3 indicate that even low surface tension liquids may cause line collapse of the kind shown in FIG. 2, as the aspect ratio increases in the manner shown in FIG. 4.

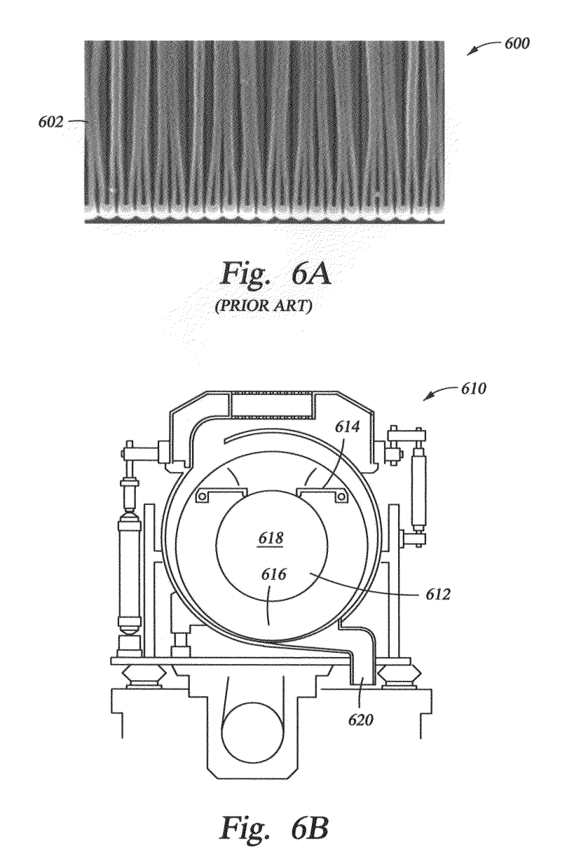

For our initial experimentation, we used a reference sample which comprised a NAND STI memory floating control gate structure. The reference structure was available from an industry customer. This reference sample 500, illustrated in FIG. 5A, was a wafer comprising lines which were separated (having a ½ pitch) of about 26 nm. The aspect ratio for the lines present on the reference sample 500 was about 12. the reference sample 500 was prepared using pattern post-etch conventional clean and dry method. This starting structure contained 41% stiction. Stiction refers to the percentage of the line walls which have collapsed to the point that they are in contact.

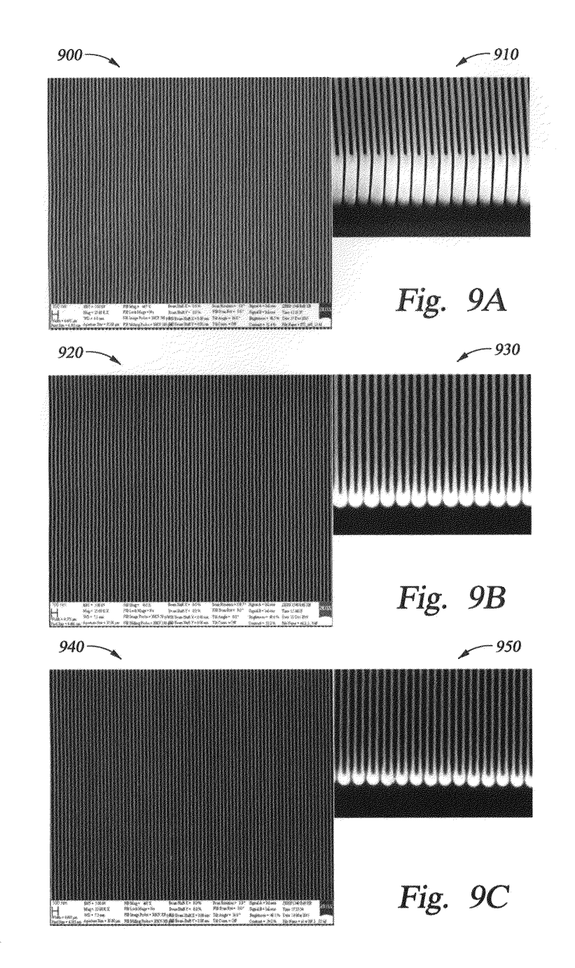

The composition of the base layer underlying the lines was silicon. The NAND STI lines were constructed in the manner shown in FIG. 8A, where the upper surface of the lines comprises silicon oxide which remains from the hardmask used during etching. FIG. 8A shows a representative drawing 800 of a film stack after etching and prior to wet clean and drying. The drawing is not to scale. The width 812 of the trench at the base of the NAND STI trenches is about 13 nm, and the aspect ratio (height of the trench walls relative to the width 812 at the base of the trench) is about 12. The base 802 of the substrate is silicon. A tunnel silicon oxide layer 804 overlying the substrate is about 7 nm thick. A polysilicon layer 805 about 95 nm thick overlies the tunnel oxide layer 804. A silicon nitride etch stop layer 806 about 30 nm thick overlies the polysilicon layer 805. The remaining hard masking layer 808 is about 90 nm thick. This was the basic structure of the specimens used during development of the present method of removing cleaning liquids from semiconductor device features.

FIG. 5A shows a photomicrograph of a starting reference structure of NAND STI lines which was the best commercially available structure, and which was used to do preliminary wet-rinse and dry experimentation.

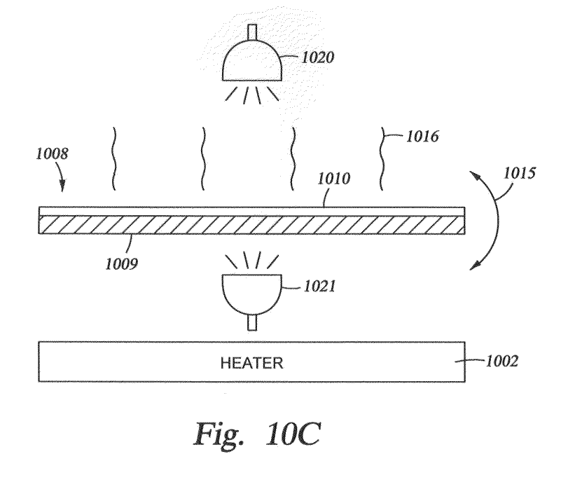

FIG. 5B shows a comparative sample embodiment produced using the starting structure shown in FIG. 5A, where the starting structure was subsequently exposed to a sprayed-on DI water rinse, followed by an IPA vapor dry at 83° C. The vapor dry was conducted using the technique shown in FIG. 10B, but without rotation of the starting structure substrate. The wetted structure was exposed to isopropyl alcohol (IPA) vapors which were condensed on the wafer surface while the wafer was in a horizontal position, with the upper surface facing downward toward uprising IPA vapors. The wafer was periodically tilted or rotated to assist the IPA in displacing the water. The IPA/water liquid covered wafer surface was constantly kept exposed to the IPA vapor during the process in which the water was removed. Once all of the water was displaced, the wafer surface was placed in a horizontal position so that the NAND STI features were facing downward, and the IPA was allowed to evaporate.

FIG. 5B shows the collapsed lines 512 and the non-collapsed lines 514 after the wet clean and dry procedure. The measured stiction after the wet clean and dry was 80%. However, since the starting structure had 41% stiction at the beginning, the increase in stiction was 39%.

FIG. 5C shows a second comparative sample embodiment produced using the starting structure shown in FIG. 5A, where the starting structure was exposed to a sprayed-on DI water rinse, followed by an ethyl acetate vapor dry at 77° C. The vapor dry was conducted using the technique shown in FIG. 10B, but without rotation of the starting structure substrate. The wetted structure was exposed to ethyl acetate vapors which were condensed on the wafer surface while the wafer was in a horizontal position with the upper surface facing downward toward uprising ethyl acetate vapors. The wafer was periodically tilted or rotated to assist the ethyl acetate in displacing the water. The ethyl acetate/water liquid covered wafer surface was constantly kept exposed to the ethyl acetate vapor during the process in which the water was removed. Once all of the water was displaced, the wafer surface was placed in a horizontal position so that the NAND STI features were facing downward, and the ethyl acetate was allowed to evaporate.

FIG. 5C shows the collapsed lines 522 and the non-collapsed lines 524 after the wet clean and dry procedure. The measured stiction was 82%. However, since the amount of stiction present in the reference sample was 41%, the increase in amount of stiction was 41%.

FIG. 5D shows a sample embodiment of the present invention produced using the starting structure shown in FIG. 5A, where the starting structure was exposed to a sprayed-on DI water rinse, followed by an acetone vapor dry at 56° C. The vapor dry was conducted using the technique shown in FIG. 10B, but without rotation of the starting structure substrate. The wetted structure was exposed to acetone vapors which were condensed on the wafer surface while the wafer was in a horizontal position with the upper surface facing downward toward uprising acetone vapors. The wafer was periodically tilted or rotated to assist the acetone in displacing the water. The acetone/water liquid covered wafer surface was constantly kept exposed to the acetone vapor during the process in which the water was removed. Once all of the water was displaced, the wafer surface was placed in a horizontal position so that the NAND STI features were facing downward, and the acetone was allowed to evaporate.

FIG. 5D shows some collapsed lines 532 and the non-collapsed lines 534 after the wet clean and dry procedure. The measured stiction was 46%. However, since the amount of stiction present in the reference sample was 41%, the increase in amount of stiction was only 5% when the drying liquid was acetone. This surprising improvement over the comparative examples illustrated in FIGS. 5B and 5C was attributed to the much higher evaporation rate of acetone, compared with the evaporation rates of isopropyl alcohol and ethyl acetate.

FIG. 6A shows a comparative photomicrograph of collapsed lines of a floating gate NAND STI structure where the collapse of the lines is due to severe stiction which occurred during a rinse clean and drying process. The aspect ratio of the lines was 12 and the spacing between the lines was 13 nm.

FIG. 6B is a schematic drawing representing a spin rinse/dryer in which a sprayed-on water cleaning rinse was applied, followed by a spin dry to remove residual water. In more detail, a wafer 612 comprising the etch patterned NAND STI structure was placed on a turn table 616 and deionized water (DI water) was sprayed from nozzles 614 onto the exposed wafer surface 618 as the turntable 616 spun, to rinse and clean the surface 618 of the wafer 612. Once the water spray was turned off, the spinning of the wafer 612 on the surface 618 of the clean and dry apparatus 610 dryer removed the water residue (not shown) on the wafer surface 618, which traveled down exit line 620, drying the sample.

FIG. 7A shows a comparative photomicrograph 710 of a floating gate NAND structure, where a portion of the lines 714 has collapsed 712 due to stiction which occurred during a rinse/cleaning process. However, the degree of stiction is not nearly as severe as that observed for the structure illustrated in FIG. 6A. An IPA vapor dryer operating based on the Marangoni method was used to remove the residual water. The aspect ratio of the lines was 12 and the spacing between the lines was 13 nm.

FIG. 7B is a schematic representing an isopropyl alcohol dryer of the kind used for drying the DI water off the surface of the NAND STI structure shown in FIG. 7A. A rinsed wafer 722, present on a holder 724, was dipped in a tank 726 of IPA. The wafer 722 was set vertically into the IPA tank 726, and could be raised and lowered as necessary, to obtain a washing action and to thereby remove water from the surface of rinsed wafer 722. The wafer 722 could be raised to permit a drip dry of the surface of the wafer 722.

FIG. 8A shows a representative drawing 800 of a film stack after etching and prior to wet clean and drying. The drawing is not to scale. The width 812 of the trench at the base of the NAND STI trenches is about 13 nm, and the aspect ratio (height of the trench walls relative to the width 812 at the base of the trench) is about 12. The base 802 of the substrate is silicon. A tunnel silicon oxide layer 804 overlying the substrate is about 7 nm thick. A polysilicon layer 805 about 95 nm thick overlies the tunnel oxide layer 804. A silicon nitride etch stop layer 806 about 30 nm thick overlies the polysilicon layer 805. The remaining hard masking layer 808 is about 90 nm thick. This was the basic structure of the specimens used during development of the present method of removing cleaning liquids from semiconductor device features.

FIG. 8B shows a photomicrograph top view 820 of a floating gate NAND STI structure of the kind shown in FIG. 8A, after use of a drying process embodiment of the present invention, where there has been no stiction during the rinse/dry cleaning process. The cleaned lines have maintained their dimensional stability during the cleaning process. The aspect ratio of the lines was 12 and the spacing between the lines was 13 nm. After completion of an etching process, this STI structure was rinsed with a DI rinse and was dried using a technique which is illustrated in FIG. 10B, where the drying liquid was acetone.

FIG. 8C shows a photomicrograph edge view 830 of a floating gate NAND STI structure after etch and prior to cleaning, where the spacing 832 between lines 834 (half pitch) is 26 nm and the stack height is about 350 nm. A comparison of FIG. 8C with FIG. 8B shows that the cleaning and drying step did not affect the dimensional stability of the floating gate structure of the device shown in FIG. 8C.

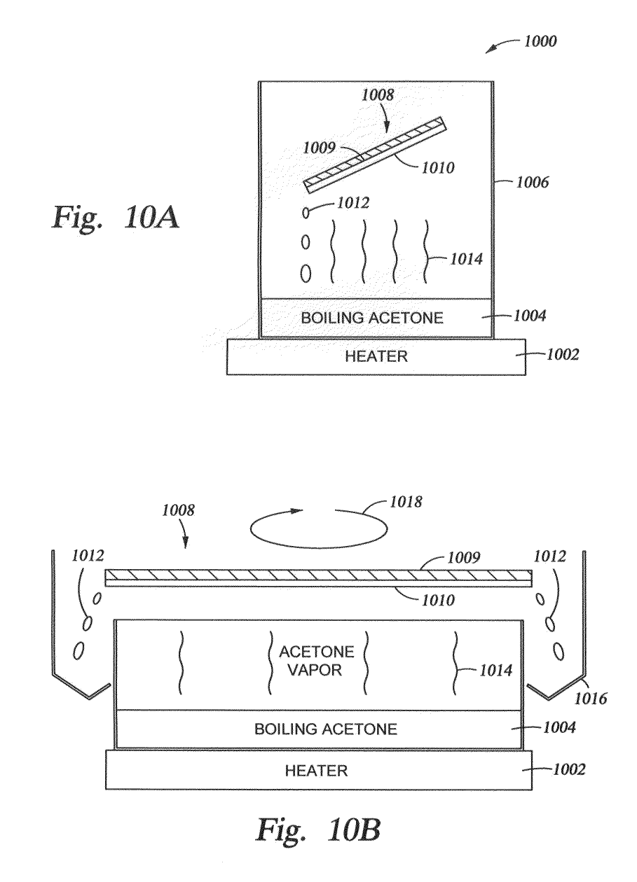

FIG. 9A shows a photomicrograph edge view 900, and a top surface view 910 of an NAND STI structure having a 26 nm spacing between trenches and an aspect ratio of 12. The photomicrograph was taken subsequent to etching of the trenches and prior to any cleaning or drying.

FIG. 9B shows a photomicrograph edge view 920 and top surface view 930 of the NAND STI structure illustrated in FIG. 9A, where the photomicrograph was taken subsequent to a DI water rinse and an acetone vapor dry in accordance with an embodiment of the present invention.

FIG. 9C shows a photomicrograph edge view 940 and top surface view 950 of an NAND STI structure of the kind illustrated in FIG. 9 A, but where an additional HF clean of the structure was carried out prior to the DI water rinse and acetone vapor dry in accordance with an embodiment of the present invention.

FIG. 10A is a schematic drawing 1000 showing one drying technique which may be used to remove residual DI rinse water from a semiconductor wafer device surface 1010 on which devices are present, for example. It is also possible to have the semiconductor wafer 1008 suspended vertically above the rising drying liquid vapors 1014. By using a restricting vapor exit (not shown) from the processing chamber 1006, it is possible to keep both the back side 1009 of the wafer and the wafer device surface 1010 completely contacted by vapor 1014 during a drying process which provides improved uniformity during drying of the wafer surface 1010. The backside of the wafer 1009 is kept covered by vapor 1014 during the drying process, and condensed vapor forms condensate 1012 which is constantly dripped off of device surface 1010. In FIG. 10, the drying liquid is shown as acetone 1004, which is caused to boil by a heater 1002 placed beneath a container holding the acetone.

FIG. 10B is a schematic drawing showing a drying technique which was determined to work particularly well, where the semiconductor wafer device surface 1010 faced horizontal to ground, with drying liquid vapors 1014 rising upward toward the wafer device surface 110. The wafer may be directly rotated 1018 to assist in the cleaning action and to direct used, condensed vapor 1012 toward a collection channel 1016 for processing to remove surface residue (not illustrated) cleaned off the wafer 1008 during the drying process.

FIG. 10C is a schematic drawing showing an alternative method of uniformly evaporating the drying fluid from the wafer device surface 1010, where the wafer device surface is facing away from ground. In addition, FIG. 10C shows an embodiment of the invention where a source of drying liquid vapor may be applied to both the device-comprising surface and the backside of a semiconductor substrate simultaneously. The vapor deposition elements 1020 and 1021 may each include feed surfaces containing a number of openings so that the drying liquid vapor may be distributed more evenly across a surface of the semiconductor substrate.

While conventional wisdom based on surface tension would have predicted, based on the information presented in Table 1, that there would not be much difference in the DI water cleaned and liquid dried NAND STI structures when the agent used for the liquid drying was IPA, ethyl acetate or acetone. However, we discovered that, given three drying liquids, where water was fully miscible with the drying liquid in each case, it is the evaporation rate of the drying liquid which determines the amount of stiction which occurs. We developed a method of removing the residual drying liquid in which the drying liquid is in the form of a vapor, where the vapor is permitted to condense on the surface of a semiconductor substrate on which devices to be dried are present. In addition, we developed an advantageous vapor application technique where the surface comprising the semiconductor devices is directly facing the direction of flow of drying vapor from the drying vapor source.

In one advantageous embodiment of the invention, the substrate is rotated so that top surfaces of the lines in the NAND STI structure are facing downward, while drying liquid vapors rise upward from below to contact the line surfaces. Once all of the DI water has been removed, in a manner such that the individual line surfaces are covered with the drying liquid, heat may be applied to increase the evaporation rate of the residual drying liquid.

The above-described exemplary embodiments are not intended to limit the scope of the present invention, as one skilled in the art can, in view of the present disclosure, expand such embodiments to correspond with the subject matter of the invention claimed below.

We claim:

1. A method of reducing the amount of stiction which occurs during fabrication of a semiconductor device, wherein said semiconductor device includes at least one feature which has an aspect ratio of 5 or greater, and wherein a spacing separating sidewalls of said feature is 50 nm or less, said method comprising: removing water from said semiconductor device surface using a drying liquid, wherein said drying liquid exhibits a miscibility with water of at least 80% and an evaporation rate of about 4 or greater when compared with butyl acetate, and wherein said drying liquid is applied in a vapor form to a device-comprising surface of said semiconductor device which includes said at least one feature.

2. A method in accordance with claim 1, wherein said drying liquid is completely miscible with water.

3. A method in accordance with claim 1 or claim 2, wherein said drying liquid vapor is applied to said device-comprising surface of said semiconductor device while said device-comprising surface is facing toward flowing drying liquid vapor.

4. A method in accordance with claim 3, wherein a direction of flow of said drying liquid vapor is perpendicular to said device surface.

5. A method in accordance with claim 1, or claim 2, wherein said semiconductor device comprises an NAND STI structure.

6. A method in accordance with claim 1, wherein said drying liquid is selected from the group consisting of acetone, butanone, 3-pentanone, propylene glycol methyl ether, 1-methoxy-2-propanol, and combinations thereof.

7. A method in accordance with claim 1, wherein said drying liquid is acetone.

8. A method in accordance with claim 2, wherein said drying liquid is selected from the group consisting of acetone, 3-pentanone, propylene glycol methyl ether, 1-methoxy-2-propanol, and combinations thereof.

9. A method in accordance with claim 8, wherein said drying liquid is acetone.

10. A method in accordance with claim 3, wherein said vapor is applied to said device-comprising surface while said surface is facing downward toward rising drying liquid vapor, so that a washing action is achieved upon condensation of vapor on said device-comprising surface, with condensed vapor dripping downward off said device-comprising surface.

11. An apparatus useful in reducing the amount of stiction which occurs during fabrication of at least one semiconductor device which includes at least one feature which has an aspect ratio of 5 or greater, and where a spacing separating sidewalls of said at least one feature is 50 nm or less, said apparatus including: a lower section which is capable of supplying drying liquid vapor and an upper section in which a semiconductor substrate may be placed, where said upper section facilitates the passage of vapor over surfaces of said semiconductor substrate.

12. An apparatus in accordance with claim 11, wherein said upper section in which said semiconductor substrate is present supports said semiconductor substrate in a manner such that a direction in which said semiconductor substrate faces may be adjusted relative to flowing drying liquid vapor supplied from said lower section.

13. An apparatus in accordance with claim 12, wherein said upper section in which said semiconductor substrate may be placed includes a turn table upon which said semiconductor substrate may be mounted, so that said semiconductor substrate may be rotated.

14. An apparatus in accordance with claim 13, wherein said turn table is mounted so that a surface of said semiconductor substrate upon which semiconductor devices are present can be made to face into drying liquid vapor supplied from said lower section or can be made to face away from drying liquid vapor supplied from said lower section.

15. An apparatus in accordance with claim 11, comprising at least one condensate collection element, wherein said drying vapor liquid which condenses on a semiconductor substrate surface in said upper section may be collected by said condensate collection element, so that said drying vapor liquid supply source is not contaminated by said condensate.

16. An apparatus in accordance with claim 11, wherein said drying liquid vapor is supplied from a surface of at least one drying liquid supply element, where there are a number of openings in said surface to provide a uniform vapor supply from said surface of said at least one drying liquid supply element.

17. An apparatus in accordance with claim 11, wherein at least one drying liquid supply element is present within said upper section of said apparatus so that both surfaces of said semiconductor substrate may be directly contacted by drying liquid vapor simultaneously.
